(19) United States
(12) Patent Application Publication
(10) Pub. No.: US 2025/0348580 A1
(43) Pub. Date: Nov. 13, 2025

(54) JAILBREAK DETECTION FOR LANGUAGE MODELS IN CONVERSATIONAL AI SYSTEMS AND APPLICATIONS

(71) Applicant: NVIDIA Corporation, Santa Clara, CA (US)

(72) Inventor: Erick Galinkin, Monroe, NC (US)

(73) Assignee: NVIDIA Corporation, Santa Clara, CA (US)

(21) Appl. No.: 18/657,947

(22) Filed: May 8, 2024

(51) Int. Cl. G06F 21/55; G06F 40/284; G06F 40/40

(52) U.S. Cl. CPC G06F 21/554; G06F 40/284; G06F 40/40; G06F 2221/034

(57) ABSTRACT

In various examples, systems and methods are disclosed relating to language model jailbreak detection using length-perplexity metrics. A system can identify a prompt for a language model—such as an LLM, VLM, etc.—and generate a perplexity score for the prompt. The system can determine, based at least on the perplexity score and a length of the prompt, that the prompt is indicative of a jailbreak attempt for the large language model. The system can restrict the prompt from input to the large language model—or block an output generated based on the prompt from being shared—responsive to determining that the prompt is indicative of the jailbreak attempt.

### BACKGROUND

Language models—such as large language models (LLMs) and vision language models (VLMs)—are trained (e.g., parameters thereof are updated) to process textual data (e.g., in natural language), audio data, image data, and/or other input data types. Under certain circumstances, such models may generate harmful, undesired, or forbidden output, which may result in computer security vulnerabilities. However, using existing solutions, it is challenging to effectively and efficiently control the output of language models.

### SUMMARY

Inputs to language models—such as LLMs, VLMs, etc.—that are designed to circumvent approaches—such as guardrails or other model alignment mechanisms—to mitigate unauthorized outputs are referred to herein as “jailbreaks” or “jailbreak attempts.” Such input prompts may be carefully crafted to include contextual content or special combinations of input tokens that may cause a language model to produce harmful, undesired, or forbidden outputs. Conventional approaches to identifying such inputs, sometimes referred to herein as conventional approaches for “jailbreak detection,” often rely on ineffective pattern/word matching, or computationally inefficient (and similarly ineffective) neural network approaches. Such word matching techniques attempt to detect jailbreak attempts by comparing an input prompt to a predetermined list of words or phrases that correspond to known jailbreak techniques. Conventional neural network approaches are computationally inefficient because they are trained to receive the input prompt as input and produce an output classification indicating whether the input is a jailbreak attempt. As techniques for jailbreaking language models constantly change and evolve, such neural network approaches are generally ineffective at classifying newer types of jailbreak attempts that are not present in their training data.

Embodiments of the present disclosure relate to language model jailbreak detection using a length-perplexity metric. The systems and methods described herein improve upon conventional techniques for jailbreak detection by using a combination of factors—such as length and perplexity—determined from an input prompt. As such, for jailbreak attempts that are disguised in lengthy or perplex input prompts, the techniques described herein can be deployed-such as to detect role-playing classes of large language model jailbreaks that would elude detection using only a single metric (e.g., perplexity). In embodiments, the length-perplexity metric uses length of the prompt as a guide to balance the overall low perplexity of role-playing style prompts that are generally longer than average instructions provided to a language model. Further, the present techniques provide improved computational performance when compared to neural network-based techniques for jailbreak detection.

At least one aspect relates to one or more processors. The one or more processors can include one or more circuits. The one or more circuits can compute a perplexity score for a prompt to a language model. The one or more circuits can compute a length of the prompt. The one or more circuits can determine, based at least on the perplexity score and the length, that the prompt is indicative of a jailbreak attempt of the language model. Responsive to determining that the prompt is indicative of the jailbreak attempt, the one or more circuits can restrict the prompt from input to the large language model and/or restrict presentation of an output of the language model generated using the prompt as input.

In some implementations, the one or more circuits can compute the perplexity score based at least on providing the prompt as input to a discrete neural network different configured to compute outputs indicating perplexity scores associated with prompts. In some implementations, the length of the prompt is computed as a function of at least one of a number of characters in the prompt or a number of tokens generated from the prompt. In some implementations, the one or more circuits can determine the number of tokens based at least on executing a tokenizer model using the prompt as input. In some implementations, the one or more circuits can generate a notification indicating that the prompt was restricted from input to the language model or that the output of the language model is restricted.

In some implementations, the one or more circuits can compute a value of a length-perplexity metric for the prompt based at least on the perplexity score and the length. In some implementations, the one or more circuits can determine that the prompt is indicative of the jailbreak attempt based at least on the value of the length-perplexity metric exceeding a threshold value. In some implementations, the one or more circuits can compute the value of the length-perplexity metric based at least on dividing the perplexity score by the length. In some implementations, the one or more circuits can compute the value of the length-perplexity metric based at least on multiplying the perplexity score by the length.

In some implementations, the one or more circuits can determine that the prompt is indicative of the jailbreak attempt further based at least on a list of predetermined words or phrases. In some implementations, the one or more circuits can receive the input prompt from a client device via a network. In some implementations, the one or more circuits can provide, via the network to the client device, a message indicating the prompt is indicative of the jailbreak attempt.

At least one aspect relates to a system. The system can include one or more circuits. The system can receive, from a client device, an input prompt for a large language model. The system can compute a value for a length-perplexity metric for the input prompt. The system can determine, based at least on the value of the length-perplexity metric, that the input prompt is indicative of a jailbreak attempt for the large language model. The system can send a message to the client device responsive to the determination that the input prompt is indicative of the jailbreak attempt.

In some implementations, the system can restrict the input prompt from input to the large language model responsive to determining that the input prompt is indicative of the jailbreak attempt. In some implementations, the system can compute the value of the length-perplexity metric for the input prompt using a machine-learning model discrete from the large language model. In some implementations, the machine-learning model comprises a transformer-based model. In some implementations, the system can compute the value of the length-perplexity metric for the input prompt based at least on a number of characters in the input prompt or a number of tokens generated from the input prompt.

At least one aspect is related to a method. The method can include identifying, using one or more processors, a prompt for a language model. The method can include generating, using the one or more processors, a perplexity score for the prompt. The method can include determining, using the one or more processors and based at least on the perplexity score and a length of the prompt, that the prompt is indicative of a jailbreak attempt for the language model. The method can include, responsive to determining that the prompt is indicative of the jailbreak attempt, at least one of restricting, using the one or more processors, the prompt from input to the language model, or restricting, using the one or more processors, presentation of an output of the language model generated using the prompt.

In some implementations, the method can include generating, using the one or more processors, the perplexity score based at least on providing the prompt as input to a neural network discrete from the language model. In some implementations, the length of the prompt is determined based at least on a number of characters in the prompt or a number of tokens generated from the prompt.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for language model jailbreak detection using length-perplexity metrics are described in detail below with reference to the attached drawing figures, wherein:

FIG. 1 is a block diagram of an example system for language model jailbreak detection using a length-perplexity metric, in accordance with some embodiments of the present disclosure;

FIG. 2 depicts a dataflow diagram showing how jailbreak detection is performed using an example length-perplexity metric, in accordance with some embodiments of the present disclosure;

FIG. 3 is a flow diagram of an example of a method for language model jailbreak detection using a length-perplexity metric, in accordance with some embodiments of the present disclosure;

FIG. 4A is a block diagram of an example generative LLM system suitable for use in implementing some embodiments of the present disclosure;

FIG. 4B is a block diagram of an example generative LLM that includes a transformer encoder-decoder suitable for use in implementing some embodiments of the present disclosure;

FIG. 4C is a block diagram of an example generative LLM that includes a decoder-only transformer architecture suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for language model jailbreak detection. Generative artificial intelligence models, such as LLMs, VLMs, etc., can employ various safeguards—such as guardrails or other model alignment mechanisms—that prevent generation of inappropriate, offensive, undesired, malicious, forbidden, or dangerous content. Such safeguards, while generally effective for normal use, may be circumvented through the use of “jailbreaks.” Jailbreaking LLMs (or other generative models) refers to the process of circumventing the safeguards placed on these models. Jailbreaking the limitations set on LLMs can potentially cause the LLMs to produce unauthorized outputs, which may be dangerous or present potential vulnerabilities for computer security, or may result in outputs that are harmful, disparaging, or otherwise undesired.

Some example jailbreaks include prompt injection, in which an initial prompt of a language model is manipulated to guide it toward unintended outputs. Prompt leaking, which is a variant of prompt injection, causes the language model to reveal its internal information. Do Anything Now (DAN) jailbreaks is a technique used to cause a generative model to generate content even if it violates safety objectives, guardrails, or other restrictions. Although certain conventional approaches are helpful in identifying certain known jailbreaks, such approaches are often easily circumvented with minor modifications to input prompts, and thus require constant updates/training to account for new jailbreak methods-meaning these prior approaches are less suitable for capturing new or dynamic jailbreak techniques.

Conventional techniques for jailbreak detection include the use of predetermined word lists, perplexity, or trained neural networks. Such techniques are not as effective for general jailbreak detection as desired. For example, each of these approaches has drawbacks for general jailbreak detection. For example, the use of perplexity alone, while a useful metric due to idiosyncrasies in the structure of certain jailbreak prompts, often fails to detect role-playing jailbreak types. The use of perplexity alone also suffers from false-positive detections of jailbreak attempts. While lists of words are suitable for detecting role-playing jailbreak attempts, word lists are easily circumvented by avoiding the specific words or lengthening the prompt such that their occurrence is rare or falls below a detection threshold. Trained neural networks also exhibit poor performance on jailbreak detection tasks that they are not trained to identify.

To address these issues, the systems and methods described herein implement a length-perplexity metric to detect jailbreak attempts based at least on the input prompt to the language model (e.g., LLM, VLM, etc.). The techniques described herein can be used to detect various classes of jailbreaks, including the role-playing class of LLM jailbreaks that would elude detection and use perplexity alone. The length-perplexity metric uses a length of the prompt as a guide to balance the overall low perplexity of role-playing style prompts that are generally longer than average instructions provided to a language model. Further, the present techniques provide improved computational performance when compared to neural network-based techniques.

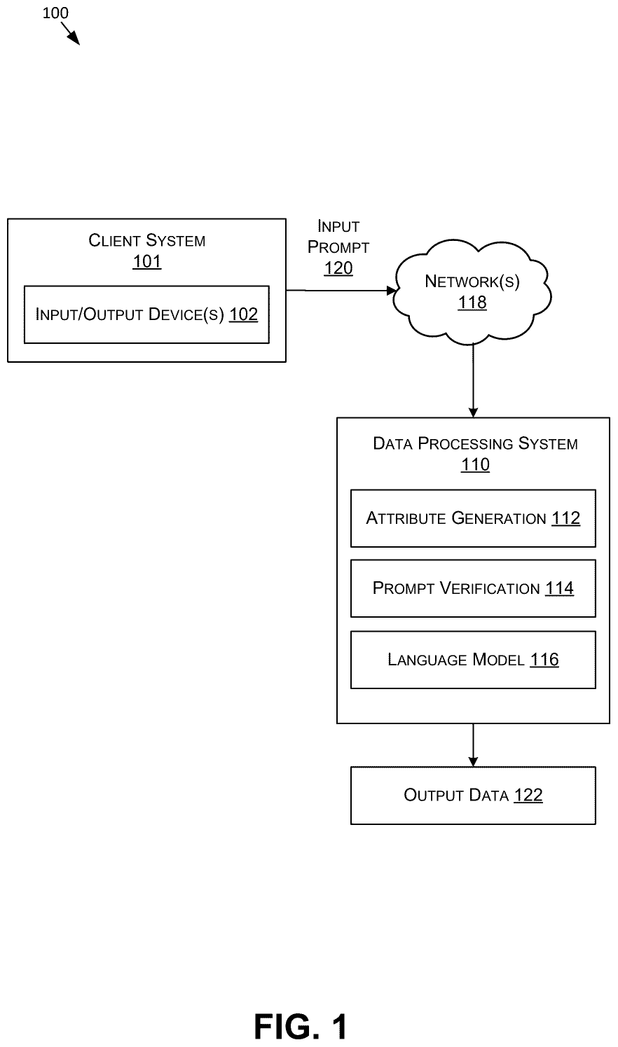

With reference to FIG. 1, FIG. 1 is an example computing environment including a system for jailbreak detection using a length-perplexity metric, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a client system 101, which may include one or more input/output device(s) 102. The client system 101 can include any type of device that is capable of communicating via a network 118, including but not limited to smartphones, laptop or mobile computers, personal computers, servers, cloud computing systems, or other types of computing systems that may generate or otherwise provide one or more input prompts 120 to at least one data processing system 110. The client system 101 can include one or more communications interfaces that enable transmission of one or more network packets via the network 118 to one or more external computing systems, which may include the data processing system 110.

In one example, the client system 101 can include input/output devices 102 that receive user input. The user input may specify one or more input prompts for a language model 116 (e.g., LLM, VLM, etc.), in some implementations. The input/output devices 102 can include touchscreen interfaces, display devices, a mouse, a keyboard, game controllers, general purpose input devices, or other types of devices capable of providing input to generate one or more input prompts 120. The input/output devices 102 of the client system 101 may include one or more display devices, audio output devices, or other output interfaces that provide output data 122 produced via a large language model 116 or a prompt verification process 114 executed by the data processing system 110. For example, the input/output devices 102 of the client system 101 may include a display device capable of presenting notifications, messages, or output prompts of the output data 122, according to the techniques described herein.

The system 100 is shown as including at least one network 118. The network 118 can include computer networks such as the Internet, local, wide, metro, or other area networks, intranets, satellite networks, cellular networks, other computer networks such as voice or data mobile phone communication networks, and combinations thereof. The event processing system 205 of the system 200 can communicate via the network 118, for instance with the broadcast provider system 215 or the client devices 280. The network 118 may be any form of computer network that can relay information between the data processing system 110, the client system 101, and one or more information sources, such as web servers, external databases, or external computing systems, amongst others.

In some implementations, the network 118 may include the Internet and/or other types of data networks, such as a local area network (LAN), a wide area network (WAN), a cellular network, a satellite network, and/or other types of data networks. The network 118 may also include any number of computing devices (e.g., computers, servers, routers, network switches, etc.) that are configured to receive and/or transmit data within the network 118. The network 118 may further include any number of hardwired and/or wireless connections.

The system 100 is shown as including at least one data processing system 110, which may be in communication with the client system 101 via the network 118. The data processing system 110 can include one or more processors, circuits, memory, and/or computing devices/systems that can perform the various techniques described herein. The data processing system 110 described herein can be implemented, for example, in a cloud computing environment, which may maintain and execute one or more large language models 116. As shown, the data processing system 110 can execute an attribute generation process 112, a prompt verification process 114, and one or more large language models 116. In some implementations, the data processing system 110 can execute one or more of the attribute generation process 112 and the prompt verification process 114, and may communicate with one or more external computing systems that maintain/execute one or more large language models 116.

As described herein, conventional approaches for large language model jailbreak detection are less effective than desired because they fail to detect many types of jailbreak attempts and may result in excessive resource utilization. To address these issues, the data processing system 110 can generate or determine a value for a length-perplexity metric for an input prompt 120 using an attribute generation process 112 and a prompt verification process 114. The input prompt 120 may include text data, or a portion of text data, which is to be provided as input to a large language model 116. In some embodiments, the input prompt 120 may additionally or alternatively include audio data, image data, and/or other data types.

In one example, the data processing system 110 can receive one or more input prompts 120 for the large language model 116 provided via the client system 101. In some implementations, the data processing system 110 may include one or more input/output devices 102 and may receive one or more input prompts 120 via user input to the data processing system 110. In some implementations, the input prompts 120 may be maintained in local memory of the data processing system 110. The attribute generation process 112 can be executed for the input prompt 120 in response to receiving the input prompt 120 and/or in response to receiving a command or message indicating the attribute generation process 112 is to be executed.

An input prompt 120 can include text data that is to be provided as input to the large language model 116. In some implementations, the input prompt 120 may be truncated or otherwise pre-processed prior to being provided as input to the large language model 116. One such pre-processing technique includes executing one or more jailbreak detection techniques. To implement the improved jailbreak detection approaches described herein, the data processing system 110 can execute an attribute generation process 112 to generate a perplexity score for the input prompt 120 and a length of the input prompt 120. In some implementations, the attribute generation process 112 can generate additional attributes for the input prompt 120, as described in further detail herein.

The attribute generation process 112 may be executed in response to receiving the input prompt 120, in some implementations. The attribute generation process 112 can be executed to process and generate one or more attributes of the input prompt 120. The attributes may include, without limitation, a perplexity score for the input prompt 120, a length of the input prompt 120, or any other attribute of the input prompt 120. The attribute generation process 112 may, in some implementations, be executed for each input prompt 120 prior to providing the input prompt 120 as input to one or more large language models 116.

To generate the perplexity score for the input prompt 120 as part of the attribute generation process 112, the data processing system 110 can provide the input prompt 120 as input to at least one machine-learning model. The input prompt 120 can provide each sequential permutation of tokens as input to the machine-learning model to calculate the probability of each next token appearing in the input prompt 120. For example, if the input prompt is “The brown dog jumps over the lazy frog,” the attribute generation process 112 can first provide the token representing “The” as input to the machine-learning model to predict the probability of the next token indicating “brown.” In the next iteration, the attribute generation process 112 can provide the tokens representing “The brown” as input to the machine-learning model to predict the probability of the next token indicating “dog.”

Although the foregoing example is described as each token indicating the entirety of a word, it should be understood that in some implementations, the machine-learning model may be trained/updated to generate tokens corresponding to any combination of words, sub-words, characters, phrases, and/or the like depending on the particular tokenization schema being used. The machine-learning model may include or may be associated with a tokenizer, which may be executed to generate tokens that may be provided as input to the machine-learning model to perform the techniques described herein. As used herein, “tokens” may include a set of a numerical representations of words, sub-words, characters, phrases, etc. corresponding to a tokenization schema with which the machine-learning model was trained/updated to process natural language.

The attribute generation process 112 to calculate the probability/likelihood of each token appearing in the input prompt 120. The machine-learning model can be any type of machine-learning model that is trained/updated to process natural language. In one example, the machine-learning model may be a transformer-based model, such as a generative pretrained transformer (GPT)-based model. The machine-learning model may be less complex and may include fewer parameters than the large language model 116, in some implementations. The machine-learning model may include a number of parameters that facilitate rapid, real-time, or near real-time execution, enabling input prompts 120 to be processed on-demand. Such models may be trained/updated to produce, given a sequence of input tokens, a set of tokens that are each predicted to be the next token in the input sequence. Each of the set of tokens can be generated with a corresponding probability value, representing the probability/likelihood of the generated token being the next token in the sequence.

To identify the probability of a given token in the input prompt 120, the attribute generation process 112 can provide the sequence of tokens that precede the given token as input to the machine-learning model. The attribute generation process 112 can then execute the machine-learning model to generate a set of predicted tokens, each having a corresponding probability value, as output. The attribute generation process 112 can search the set of generated tokens to identify the token for which the probability is to be generated. The probability value for that token generated by the machine-learning model is assigned to the token in the input prompt 120. This process is then repeated for each token in the input prompt 120 to generate probability values for each token in the input prompt 120.

Once the probability values for each token have been generated, the attribute generation process 112 can generate a perplexity score for the input prompt 120 using the set of probability values. The perplexity score for the input prompt 120 (sometimes referred to herein as the “perplexity’ of the input prompt 120) can be calculated using the following equation, in some implementations, which is represented in terms of log probabilities:

$$PP ( W ) = exp ( - \frac{1}{N} {\sum }_{i}^{N} log P ( {w}_{i} ) )$$

In the above equation, the value PP is the perplexity of the input prompt 120 (represented as W), the value P(wᵢ) represents the probability of the token i in the text data W, and the value N is equal to the number of tokens generated from the text data W (e.g., by the tokenizer of the machine-learning model).

In addition to calculating the perplexity, the attribute generation process 112 can generate a length of the input prompt 120. The length of the input prompt 120 can be representative of any type of length metric of the input prompt 120. In some implementations, the length may be a number of characters in the input prompt 120. In some implementations, the length may be number of tokens in the input prompt 120, a number of words in the input prompt 120 (e.g., by splitting on whitespace), or a number of phrases, clauses, or other sub-divisions of the input prompt 120.

The number of tokens can be generated by providing the input prompt 120 as input to a tokenizer model. The tokenizer model may be trained/updated to generate tokens for the machine-learning model and/or the large language model 116 maintained or otherwise accessed by the data processing system 110. In some implementations, the length of the input prompt 120 can be calculated by accessing the raw text data of the input prompt 120 to calculate the total number of characters in the input prompt 120. In some implementations, the total number of characters may be inclusive or exclusive of whitespace. In some implementations, additional attributes of the input prompt 120 may be calculated by the attribute generation process 112, including but not limited to a number of words in the input prompt 120, a number of sentences in the input prompt 120, or a number of special characters (e.g., characters that are not a standard letter or number) in the input prompt 120, among others.

Each of the attributes generated by the attribute generation process 112 can be stored and provided to the prompt verification process 114. The prompt verification process 114 can generate indications of whether the input prompt 120 is a potential jailbreak attempt for the large language model 116 based at least on the calculated attributes (e.g., length, perplexity, etc.). To do so, the prompt verification process 114 can generate a value for a length-perplexity metric for the input prompt 120 based at least on the generated length and perplexity of the input prompt 120.

In some implementations, the length-perplexity metric is calculated as a product (or other function) of the length and the perplexity score, for example, by multiplying the length of the input prompt 120 (e.g., number of characters, number of tokens) by the perplexity score for the input prompt 120. In some implementations, the value of the length-perplexity metric is calculated as a quotient of the length and the perplexity score, for example, by dividing the length by the perplexity score (or vice versa) for the input prompt 120. The length-perplexity metric, once generated by the prompt verification process 114, can be stored in association with the input prompt 120.

To determine whether the input prompt 120 corresponds to a jailbreak attempt for the large language model 116, the prompt verification process 114 can compare the length-perplexity metric to a threshold. In some implementations, the threshold can be specified as part of a configuration setting maintained by the data processing system 110. The configuration setting can be specified, in one example, via input to the data processing system 110 or via a message transmitted by one or more external computing systems (e.g., an administrator computing system, etc.). In some implementations, the configuration setting may be updated based at least on feedback indicating that one or more input prompts 120 are to be restricted.

In some implementations, the length-perplexity metric may be used as one factor in determining whether the input prompt 120 represents a jailbreak attempt. For example, the data processing system 110 may compute multiple scores or values to generate a composite score representing the overall likelihood that the input prompt 120 represents a jailbreak attempt. One example score may be a number of words/phrases/tokens in the input prompt 120 that appear in a predetermined list of words that are likely to be included in jailbreak attempts. Configurable weight values can be applied to each of the length-perplexity metric and the number of matching number of words/phrases/tokens to calculate respective scores for each factor. Any number of factors can be used to calculate the composite score. The prompt verification process 144 can calculate the composite score as a sum of the weighted values (e.g., a weighted sum). The composite score can be compared to a corresponding threshold to determine whether the input prompt 120 corresponds to a jailbreak attempt, using techniques similar to those described above.

If the input prompt 120 is determined to correspond to a jailbreak attempt, the prompt verification process 114 can restrict the input prompt 120 from input to the large language model 116. Restricting the input prompt 120 may include bypassing processing of the prompt by the large language model 116 and/or subsequently generating the output data 122 to include a message or indication that the input prompt 120 was invalid. For example, the prompt verification process 114 can generate the output data 122 to include a message that indicates that the input prompt 120 was a jailbreak attempt (e.g., “the input prompt (or the expected output as a result) is illegal/undesired/unauthorized/vulgar/security risk/etc.”). In some implementations, the message provided as the output data 122 may be predetermined and stored in memory of the data processing system 110. In some implementations, in addition to providing a message in lieu of output from the large language model 118, the prompt verification process 114 can store an indication that the input prompt 120 indicated a jailbreak attempt. The indication may include a timestamp corresponding to when the input prompt 120 was provided to the data processing system 110, as well as additional information relating to a source of the input prompt (e.g., an identifier of the client system 101, relevant usernames, emails, or other login information, etc.).

In some implementations, the prompt verification process 114 can restrict the inclusion of the output of the large language model 116 in the output data 122. For example, in some implementations, the attribute generation process 112, the prompt verification process 114 and the large language model 116 may be executed in parallel using the input prompt 120 described herein. Output of the large language model 116 may be generated and stored in memory of the data processing system 110 while the prompt verification process 114 determines whether the input prompt 120 corresponds to a jailbreak attempt. If the prompt verification process 114 determines that the input prompt 120 corresponds to a jailbreak attempt for the large language model 116, the output generated by the large language model 116 is not included as part of the output data 122, which is replaced by a message or indication as described herein.

If the prompt verification process 114 determines that the input prompt 120 does not correspond to a jailbreak attempt for the large language model 116, the prompt verification process 114 can permit use of the prompt verification process 114 to generate an output using the large language model 116. For example, in some implementations, the prompt verification process 114 can provide the input prompt 120 as input to the large language model 116. In some implementations, the prompt verification process 114 can generate an input for the large language model 116 by appending, concatenating, or otherwise incorporating additional tokens and/or prompt data (e.g., a system prompt, etc.) to the input prompt 120. In implementations where the prompt verification process 114 executes in parallel with the large language model 116, the prompt verification process 114 can generate the output data 122 to include the output of the large language model 116.

The language model 116 can be any type of text-based or multimodality language model capable of processing natural language text input, audio input, image input, etc. The large language model 116 may be or include a transformer-based model (e.g., a generative pre-trained transformer (GPT) model). The large language model 116 may be or include a vision language model (VLM), in some implementations. The large language model 116 may include a tokenizer model or portion that converts raw text or media data into an encoded format (e.g., one or more tokens, or a “tokenized” format) that is compatible with the layers of the large language model 116.

The data processing system 110 can execute the large language model 116 using at least the input prompt 120 as input. Executing the large language model 116 can include tokenizing the raw text information of the input prompt 120 and processing the tokens through multiple embedding and/or transformer layers. The large language model 116 can use autoregressive language modeling to generate text sequentially. For example, the large language model 116 can predict the token in the sequence of input tokens and any tokens previously generated by the large language model 116 for that input prompt 120.

Executing the large language model 116 can include performing one or more sampling techniques, such as softmax sampling or top-k sampling, to select the next token from a probability distribution generated using the large language model 116. The large language model 116 can be executed iteratively, incorporating previously generated tokens as context for generating subsequent tokens, until a termination condition has been reached. One type of termination condition can be a context length limit or a configurable limit on the number of tokens that can be generated and/or processed by the large language model 116. In some implementations, the termination condition can be satisfied when the large language model 116 generates a token that represents the end of a response to the input prompt 120. The large language model 116 may be trained/updated to be a conversational agent. For example, the large language model 116 can generate realistic natural language in response to natural language input.

Text data can be generated by detokenizing the tokens generated using the large language model 116 (e.g., using the tokenizer model associated with the large language model 116, etc.). Output text generated by the large language model 116 can be provided as part of the output data 122. The output data 122 can include text data generate using the large language model 116. As described herein, if the input prompt 120 is determined to correspond to a jailbreak attempt, the prompt verification process 114 can replace or otherwise substitute the text of the large language model 116 with another message, prompt, or indication that the input prompt 120 is invalid. One example of such message may be “Please reword your prompt.”

The output data 122 may be provided for display at the computing system that provided the input prompt 120. For example, the output data 122 can be provided as input to the client system 101 for display via the input/output device(s) 102. If the input prompt 120 is received via input to the data processing system 110, the data processing system 110 can provide the output data 122 via an output device of the data processing system 110.

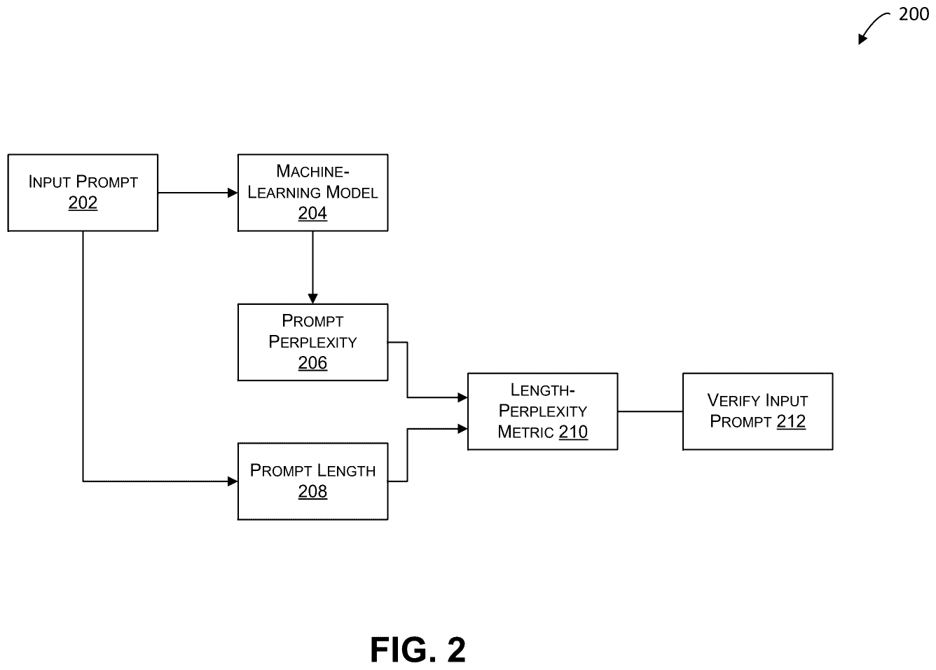

Referring to FIG. 2, illustrated is a dataflow diagram 200 showing how jailbreak detection is performed using an example length-perplexity metric, in accordance with some embodiments of the present disclosure. The process shown in the dataflow diagram 200 can be performed, for example, by the data processing system 110 of FIG. 1, as described herein. As described herein, jailbreak detection techniques can be applied to an input prompt 202 (which may be similar to the input prompt 120 of FIG. 1) to determine whether the input prompt 202 represents an attempt to cause a large language model (e.g., the large language model 116 of FIG. 1) to generate unauthorized or unsafe output.

In this example, prompt perplexity 206 of the input prompt 202 is calculated by iteratively providing the input prompt to a machine-learning model 204. The machine-learning model 204 may be a model that includes fewer parameters compared to a large language model. As described herein, the machine-learning model 204 can be iteratively executed to calculate the probability/likelihood of each token appearing in the input prompt 202. The probability values can then be used to generate the prompt perplexity 206 according to the techniques described herein. The prompt perplexity 206 can reflect the confidence that the machine-learning model 204 can predict each token in the input prompt 202. A lesser perplexity value indicates that the machine-learning model 204 is more confident and accurate in predicting the input prompt 202, while a greater perplexity value indicates that the machine-learning model 204 is less confident in predicting the input prompt 202.

The prompt length 208 of the input prompt is also calculated, as described herein. The prompt length 208 may correspond to any suitable length metric that generally describes the length of the prompt. For example, the prompt length 208 may be a number of characters (e.g., including or excluding whitespace) in the input prompt 202, a number of words in the input prompt 202, a number of phrases/sentences in the input prompt 202, or a number of tokens generated from the input prompt 202 (e.g., as generated using a suitable tokenizer model, etc.). The prompt perplexity 206 and the prompt length 208 are used to calculate a length-perplexity metric 210 for the input prompt 202. The length-perplexity metric 210 can be calculated as a product (or as another project) of the prompt perplexity 206 and the prompt length 208, as a quotient of the prompt perplexity 206 and the prompt length 208, or as any other function of each of the prompt perplexity 206 and the prompt length 208.

The length-perplexity metric 210 can be used as a factor in input prompt verification process 212 to determine whether the prompt corresponds to a jailbreak attempt. The length-perplexity metric 210 may be used as the sole factor, or one of many factors, in the determination. In one example, the prompt verification process 212 can compare the length-perplexity metric 210 to a predetermined threshold. If the length-perplexity metric 210 exceeds the threshold, the input prompt 202 is determined to be a jailbreak attempt for a large language model. If the length-perplexity metric 210 does not exceed the threshold, the input prompt 202 is not determined to correspond to a jailbreak attempt and may be provided as input to a large language model for further processing. The prompt verification process 212 may calculate a composite score for the input prompt 202 by calculating a weighted sum for multiple factors (e.g., length-perplexity metric 210, a number of words/tokens/phrases in the input prompt that match a predetermined list, etc.), as described herein. The composite score may also be used to determine whether the input prompt 202 is a jailbreak attempt.

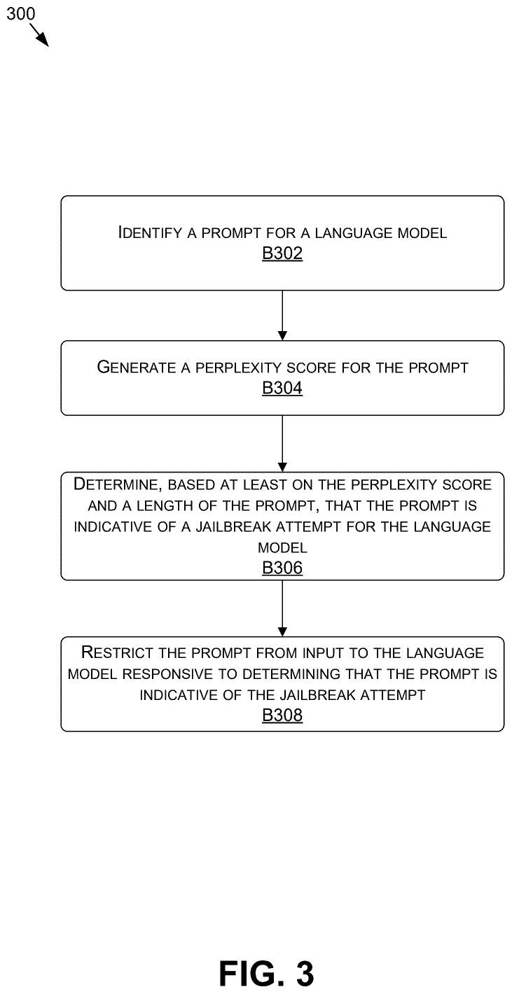

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for large language model jailbreak detection using a length-perplexity metric, in accordance with some embodiments of the present disclosure. The method 300, at block B302, includes identifying a prompt (e.g., the input prompt 120) for a large language model (e.g., the large language model 116). The prompt may be received from a client device (e.g., the client system 101) via a network (e.g., the network 118). The prompt can include a text-based natural language prompt. In some implementations, the prompt may be a multimodal prompt that includes text data. In some implementations, the prompt may be an audio prompt that is converted to text format using a speech recognition model. In some implementations, the prompt may be provided via input to the computing system (e.g., the data processing system 110) performing the method 300.

The method 300, at block B304, include generating a perplexity score for the prompt. The perplexity score can be by providing the prompt as input to a neural network (e.g., the machine-learning model 204) different from the large language model. The neural network may be a transformer-based model, such as a GPT-based model. To do so, the prompt can be tokenized or otherwise converted into a format compatible with the neural network. The resulting sequence of tokens can then be iteratively provided as input to the neural network. For each token in the sequence, the neural network is used to predict the probability distribution for the next token. Represented mathematically, for each token tᵢ, the probability p(tᵢ|t₀, t₁, . . . , tᵢ₋₁). The perplexity score can be generated by using the calculated probability values to determine the exponential of the average negative log likelihood of the tokens in the sequence.

The method 300, at block B306, includes determining, based at least on the perplexity score and a length of the prompt, that the prompt is indicative of a jailbreak attempt for the large language model. The length of the prompt can include the number of characters in the prompt, or the number of tokens generated from the prompt. To calculate the number of tokens in the prompt, a tokenizer model can be executed using the prompt as input. The tokenizer model may correspond to the large language model or may be a separate tokenizer model. A length-perplexity metric (e.g., the length-perplexity metric 210) can be calculated to determine whether the prompt is indicative of a jailbreak attempt for the large language model.

In some implementations, the length-perplexity metric is generated by dividing the perplexity score by the length (or vice versa). In some implementations, the length-perplexity metric is generated by multiplying the perplexity score by the length. The length-perplexity metric can be compared to a threshold to determine whether the prompt is indicative of a jailbreak. The threshold may be a predetermined threshold, as described herein, which may be reconfigured according to user input in some implementations. If the length-perplexity metric exceeds a threshold, the prompt can be identified as corresponding to a jailbreak attempt. In some implementations, a composite score may be calculated as a weighted sum of multiple factors for the prompt, as described herein.

The method 300, at block B308, includes restricting the prompt from input to the large language model responsive to determining that the prompt is indicative of the jailbreak attempt. Restricting the prompt from input to the large language model can include preventing the prompt from being provided as input to the large language model. Rather than providing the output of the large language model, a notification indicating that the prompt was restricted from input to the large language model can be generated. The notification may be a generic message requesting that the prompt be re-worded or re-phrased. The message can be provided for display at the computing system that provided the prompt, such as a client device in communication with the computing system performing the method 300. If the prompt determined to not correspond to a jailbreak attempt for the large language model, the prompt can be provided as input to the large language model and the output of the large language model can be provided for display.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Large Language Models

Large language models (LLMs) are a type of generative artificial intelligence (AI) that can understand, summarize, translate, or otherwise generate human-like text based on the context provided in input prompts or queries. These language models are often considered “large” based on their training on massive datasets and having architectures with large number of learnable network parameters (weights and biases), with popular LLMs having millions or billions of parameters. LLMs have become proficient in summarizing textual data, analyzing and extracting insights from data, and generating new text in user-specified styles, tones, or formats. Some LLMs like the early versions of chatbots (e.g., ChatGPT) focus exclusively on text processing, whereas some multimodal LLMs can accept, understand, and/or generate text along with other types of content like images, audio, and/or video. For example, visual language models (VLMs) are a type of LLM that can accept visual and textual input and/or generate visual and textual output.

There are different types of LLM architectures that use different techniques for understanding and generating human-like text. Some early LLM architectures used recurrent neural networks (RNNs) or long short-term memory networks (LSTMs), whereas many modern LLMs use a transformer architecture that relies on self-attention mechanisms to understand and recognize relationships between words or tokens. An LLM may include encoder and/or decoder block(s). Discriminative or encoder-only LLMs like BERT (Bidirectional Encoder Representations from Transformers) are well-suited for tasks that involve language comprehension such as classification, sentiment analysis, question answering, and named entity recognition. Generative or decoder-only LLMs like GPT (Generative Pretrained Transformer) are well-suited for tasks that involve language and content generation such as text completion, story generation, and dialogue generation. LLMs that include both encoder and decoder components like T5 (Text-to-Text Transformer) can understand and generate content, making these models well-suited for tasks such as translation and summarization.

LLMs are primarily trained using unsupervised learning, in which an LLM learns patterns from large amounts of unlabeled text data. Due to their extensive training, LLMs often do not require task-specific or domain-specific training. These types of LLMs that have undergone extensive pre-training on vast amounts of unlabeled text data are often referred to as foundation models and are adept at a variety of tasks like question-answering, summarization, filling in missing information, and translation. Some LLMs may be tailored for a specific use case using techniques like prompt tuning, fine-tuning, and/or adding adapters.

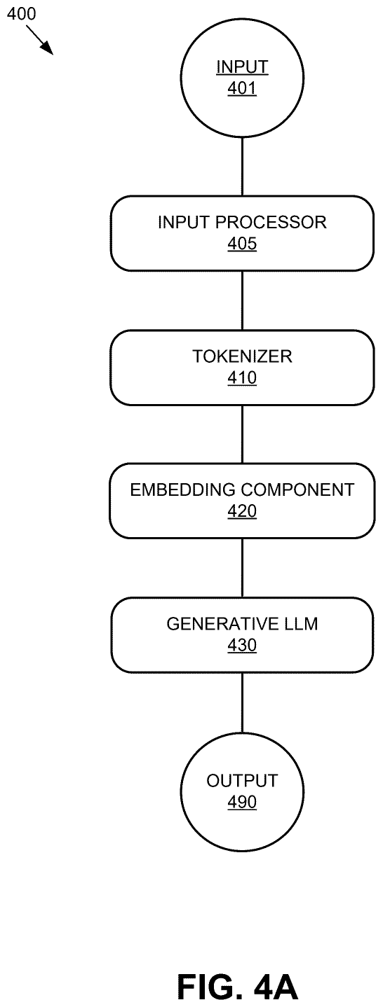

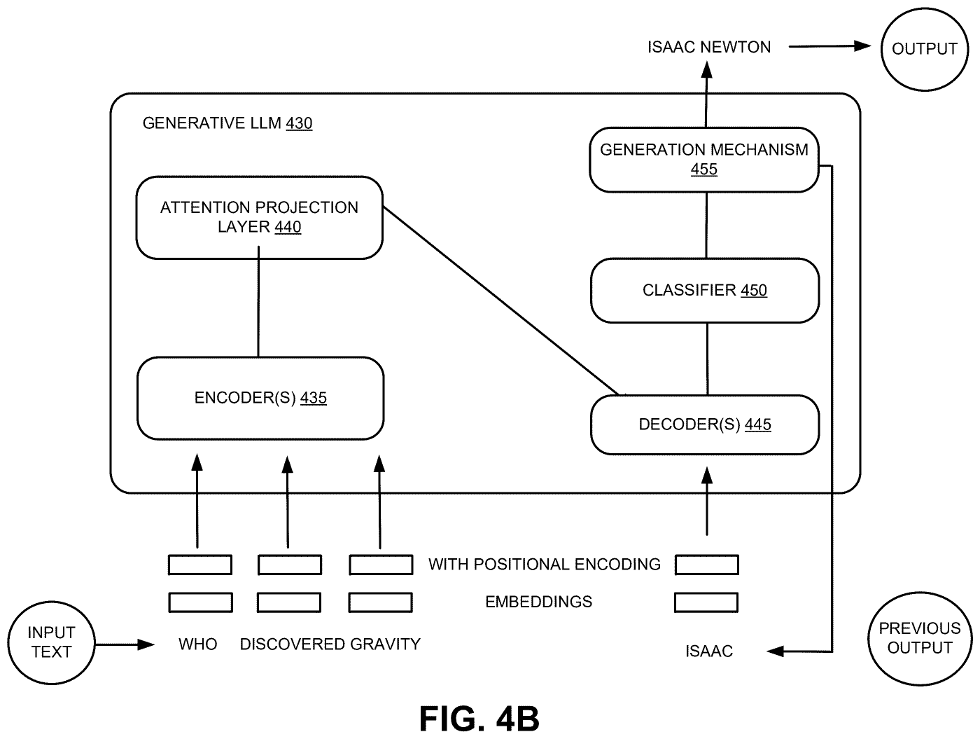

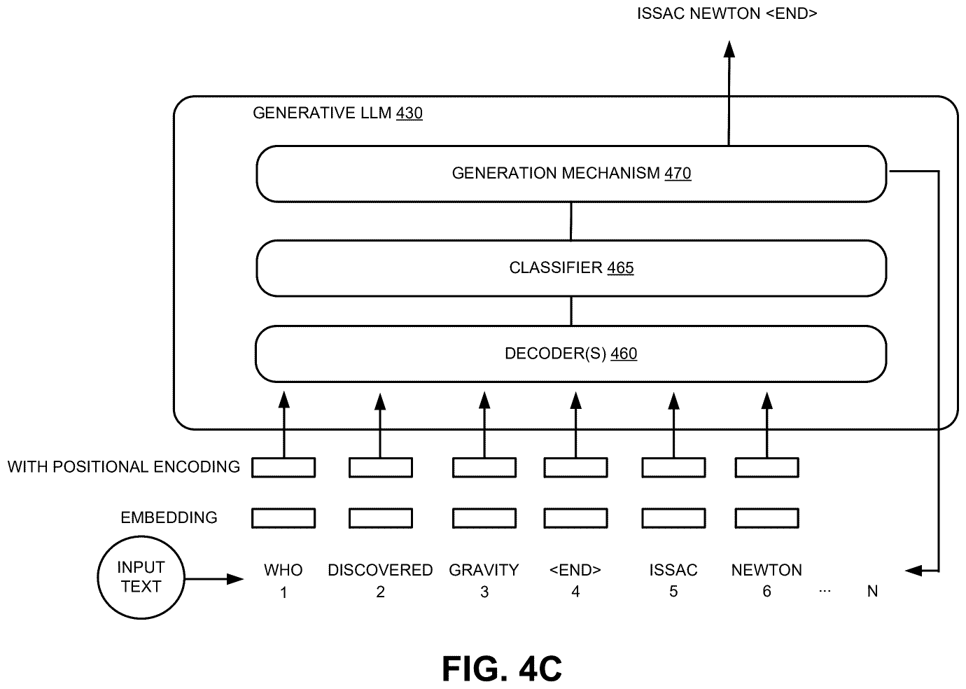

FIG. 4A is a block diagram of an example generative LLM system 400 suitable for use in implementing some embodiments of the present disclosure. In the example illustrated in FIG. 4A, the generative LLM system 400 includes an input processor 405, a tokenizer 410, an embedding component 420, and a generative LLM 430.

At a high level, the input processor 405 may receive an input 401 comprising text and other types of input data, depending on the architecture of the generative LLM 430. Typically, the input 401 includes plain text in the form of one or more sentences, paragraphs, or documents. Additionally or alternatively, the input 401 may include numerical sequences, precomputed embeddings (e.g., word or sentence embeddings), and/or structured data (e.g., in tabular formats, JSON, or XML). In some implementations in which the generative LLM 430 is capable of processing multimodal inputs, the input 401 may combine text with image data, audio data, and/or other types of input data. Taking raw input text as an example, the input processor 405 may prepare raw input text in various ways. For example, the input processor 405 may perform various types of text cleaning to remove noise (e.g., special characters, punctuation, HTML tags, stopwords) from relevant textual content. In an example involving stopwords (common words that tend to carry little semantic meaning), the input processor 405 may remove stopwords to reduce noise and focus the generative LLM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

The tokenizer 410 may segment the (e.g., processed) text into smaller units (tokens) for subsequent analysis and processing. The tokens may represent individual words, subwords, or characters, depending on the implementation. Word-based tokenization divides the text into individual words, treating each word as a separate token. Subword tokenization breaks down words into smaller meaningful units (e.g., prefixes, suffixes, stems), enabling the generative LLM 430 to understand morphological variations and handle out-of-vocabulary words more effectively. Character-based tokenization represents each character as a separate token, enabling the generative LLM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data, the input processor 401 may resize the image data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features. In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multimodal data, the embedding component 420 may fuse representations of the different types of data (e.g., text, image, audio) using techniques like early fusion (concatenation), late fusion (sequential processing), attention-based fusion, etc.

The generative LLM 430 and/or other components of the generative LLM system 400 may use different types of neural network architectures depending on the implementation. Transformer-based architectures such as those used in models like GPT typically include self-attention mechanisms that weigh the importance of different words or tokens in the input sequence and feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LLM 430, and the generative LLM 430 may process the encoded representation of the input 401 to generate an output 490, which may include responsive text and/or other types of data.

FIG. 4B is a block diagram of an example implementation in which the generative LLM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LLM 430.

In an example implementation, the encoder(s) 435 form an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LLM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

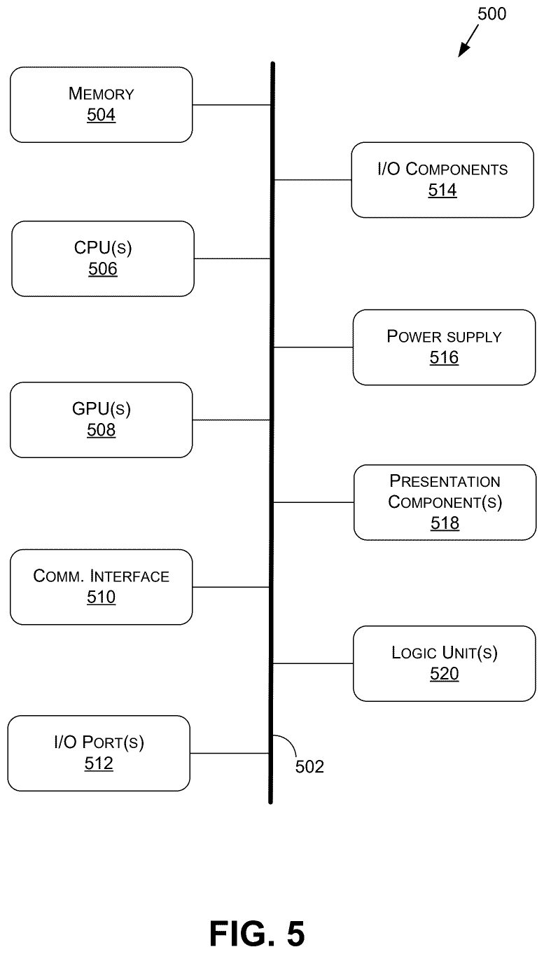

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

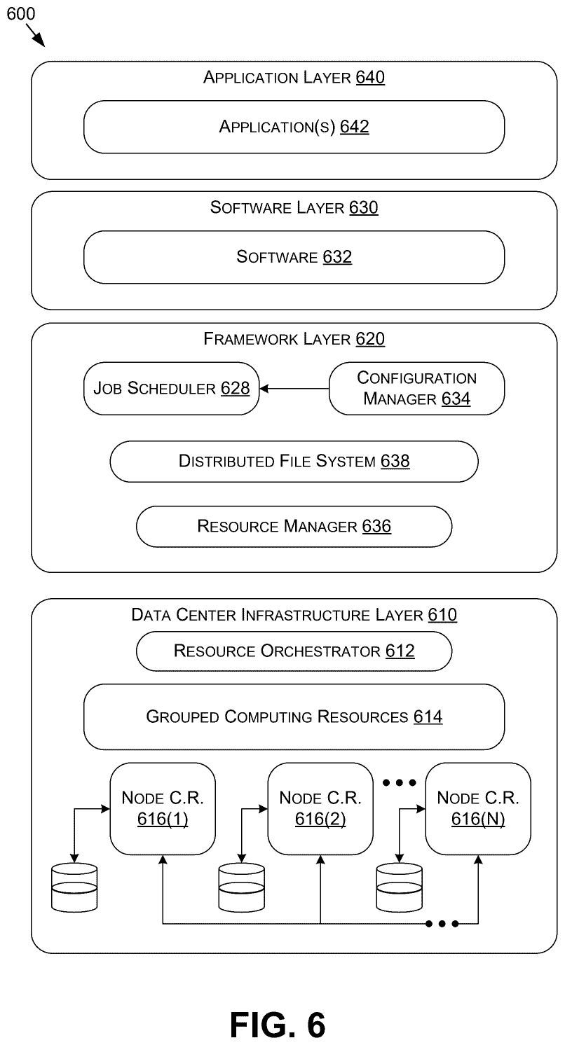

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
compute a perplexity score for a prompt to a language model;
compute a length of the prompt;
determine, based at least on the perplexity score and the length, that the prompt is indicative of a jailbreak attempt of the language model; and
responsive to determining that the prompt is indicative of the jailbreak attempt, at least one of:
restrict the prompt from input to the language model; or
restrict presentation of an output of the language model generated using the prompt as input.

2. The one or more processors of claim 1, wherein the one or more circuits are to compute the perplexity score based at least on providing the prompt as input to a discrete neural network configured to compute outputs indicating perplexity scores associated with prompts.

3. The one or more processors of claim 1, wherein the length of the prompt is computed as a function of at least one of a number of characters in the prompt or a number of tokens generated from the prompt.

4. The one or more processors of claim 3, wherein the one or more circuits are to determine the number of tokens based at least on executing a tokenizer model using the prompt as input.

5. The one or more processors of claim 1, wherein the one or more circuits are to generate a notification indicating that the prompt was restricted from input to the language model or that the output of the language model is restricted.

6. The one or more processors of claim 1, wherein the one or more circuits are to:
compute a value of a length-perplexity metric for the prompt based at least on the perplexity score and the length; and
determine that the prompt is indicative of the jailbreak attempt based at least on the value of the length-perplexity metric exceeding a threshold value.

7. The one or more processors of claim 6, wherein the one or more circuits are to compute the value of the length-perplexity metric based at least on dividing the perplexity score by the length.

8. The one or more processors of claim 6, wherein the one or more circuits are to compute the value of the length-perplexity metric based at least on multiplying the perplexity score by the length.

9. The one or more processors of claim 1, wherein the one or more circuits are to determine the prompt is indicative of the jailbreak attempt further based at least on a list of predetermined words or phrases.

10. The one or more processors of claim 1, wherein the one or more circuits are to:
receive the prompt from a client device via a network; and
provide, via the network to the client device, a message indicating the prompt is indicative of the jailbreak attempt.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

12. A system comprising:
one or more processors to:
receive, from a client device, an input prompt for a large language model;
compute a value for a length-perplexity metric for the input prompt;
determine, based at least on the value of the length-perplexity metric, that the input prompt is indicative of a jailbreak attempt for the large language model; and
send a message to the client device responsive to the determination that the input prompt is indicative of the jailbreak attempt.

13. The system of claim 12, wherein the one or more processors are to restrict the input prompt from input to the large language model responsive to determining that the input prompt is indicative of the jailbreak attempt.

14. The system of claim 12, wherein the one or more processors are to compute the value of the length-perplexity metric for the input prompt using a machine-learning model discrete from the large language model.

15. The system of claim 14, wherein the machine-learning model comprises a transformer-based model.

16. The system of claim 12, wherein the one or more processors are to compute the value of the length-perplexity metric for the input prompt based at least on a number of characters in the input prompt or a number of tokens generated from the input prompt.

17. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

18. A method, comprising:
identifying, using one or more processors, a prompt for a language model;
generating, using the one or more processors, a perplexity score for the prompt;
determining, using the one or more processors and based at least on the perplexity score and a length of the prompt, that the prompt is indicative of a jailbreak attempt for the language model; and
responsive to determining that the prompt is indicative of the jailbreak attempt, at least one of:
restricting, using the one or more processors, the prompt from input to the language model; or
restricting, using the one or more processors, presentation of an output of the language model generated using the prompt.

19. The method of claim 18, further comprising generating, using the one or more processors, the perplexity score based at least on providing the prompt as input to a neural network discrete from the language model.

20. The method of claim 18, wherein the length of the prompt is determined based at least on a number of characters in the prompt or a number of tokens generated from the prompt.
